(19) United States
(12) Patent Application Publication
(10) Pub. No.: US 2025/0383846 A1
(43) Pub. Date: Dec. 18, 2025

(54) AUTOMATED ADAPTATION OF EMBEDDED SOFTWARE

(71) Applicant: Robert Bosch GmbH, Stuttgart (DE)

(72) Inventors: Jesko Hecking-Harbusch, Leonberg (DE); Jochen Quante, Ludwigsburg (DE); Matthias Woehrle, Bietigheim-Bissingen (DE)

(21) Appl. No.: 19/236,174

(22) Filed: Jun. 12, 2025

(30) Foreign Application Priority Data
Jun. 14, 2024 (EP) 24182380.6

(51) Int. Cl. G06F 8/35; G06F 8/70; G06F 11/3668

(52) U.S. Cl. CPC G06F 8/35; G06F 8/70; G06F 11/3688

(57) ABSTRACT

A computer-implemented method for the automated generation of a code element of a software code includes (i) generating, via a machine learning model, the code element based on a language specification for the code element to be created and an interface test criterion that is to be satisfied by the code element to be created, optionally wherein a prompt to the machine learning model includes the language specification and the interface test criterion, and (ii) testing whether the code element satisfies the interface test criterion, thus providing a test result.

This application claims priority under 35 U.S.C. § 119 to patent application no. EP 24182380.6, filed on Jun. 14, 2024 in the European Patent Office, the disclosure of which is incorporated herein by reference in its entirety.

### BACKGROUND

Software such as embedded software for controlling, regulating, and/or monitoring technical systems, particularly cyber-physical systems such as computing units of a vehicle and/or a robot, typically has a high degree of complexity. As a result, it is challenging for individual software engineers and even entire software development departments to keep track of the software and its changes, especially throughout its entire lifecycle (development, testing, production and maintenance).

Adjustments and/or rewrites to the software may be necessary throughout the life cycle, but particularly in the development and testing phases. For example, detected bugs or weaknesses must be continuously corrected and/or the software must be adapted to new and/or changed functionality. It may also be desirable to adjust the code for changed conditions in terms of run-time, memory usage, readability, and/or maintainability.

Machine learning models, in particular Foundation Models or Large Language Models (LLMs), may generate code or portions thereof (hereinafter: code elements) based on a prompt, e.g., a natural language instruction to the machine learning model. This may be used, for example, to extend or refactorize an existing code by one or more code elements, i.e. to replace one or more existing parts of the code with one or more code elements, in particular with respect to the changed conditions.

Since machine learning models may hallucinate, however, there is thus far a lack of a guarantee as to the accuracy of the code elements generated by the machine learning model and/or that these code elements fit with and within the code. It is also possible that the generated code cannot, for example, even be compiled or does not meet the requirements placed on it or does not completely meet them.

Therefore, the disclosure solves the problem of being able to automatically but reliably revise software code, thus generating suitable code elements for a code.

### SUMMARY

A first general aspect of the present disclosure relates to a computer-implemented method for automated generation of a code element of a software code. The method comprises generating 120, via a machine learning model, the code element based on a language specification for the code element to be created and an interface test criterion to be satisfied by the code element to be created. A prompt to the machine learning model may include the language specification and the interface test criterion. The method further comprises testing whether the code element satisfies the interface test criterion, wherein a test result is provided.

The software may be configured to control, regulate and/or monitor a technical system, in particular a cyber-physical system, in particular at least one computing unit of a vehicle and or a robot. In particular, the software may be embedded software. The method may be performed in an electronic programming environment.

The method may further comprise integrating the code element into the code, at least when the test result is sufficiently positive, wherein a revised code results. The code may be expanded by the code element or a previous code element in the code may be replaced by the code element. The method may further comprise executing the revised code (e.g., in compiled form) in a technical system, particularly a cyber-physical system, particularly in a computing unit of a vehicle and/or a robot.

A second general aspect of the present disclosure relates to a computer-implemented method for further training of a machine learning model, wherein the machine learning model is configured to generate a code element of a software code based on a language specification for the code element to be created and an interface test criterion to be satisfied by the code element to be created. The method comprises adjusting the machine learning model based on a test result, wherein the test result is the result of testing whether the code element satisfies the interface test criterion. The method according to the second general aspect (or one embodiment) may be performed, but need not be performed, according to the method according to the first general aspect (or one embodiment thereof).

The code element may have been generated and tested according to the method for automated generation of a code element of a software code according to the first general aspect (or embodiment thereof).

A third general aspect of the present disclosure relates to a computer system designed to perform the computer-implemented method for automated generation of a code element of a software code according to the first general aspect (or an embodiment thereof) and/or the computer-implemented method for training of a machine learning model according to the second general aspect (or an embodiment thereof).

A fourth general aspect of the present disclosure relates to a computer program designed to perform the computer-implemented method for automated generation of a code element of a software code according to the first general aspect (or an embodiment thereof) and/or the computer-implemented method for training of a machine learning model according to the second general aspect (or an embodiment thereof).

A fifth general aspect of the present disclosure relates to a computer-readable medium or signal that stores and/or contains the computer program according to the fourth general aspect (or an embodiment thereof).

The method according to the first aspect (or an embodiment thereof) proposed in this disclosure is directed toward the automated generation of a code element of a software code. By the method proposed herein, a software code may be purposefully revised at one or more locations. For example, a portion of the software code may be replaced by a generated code element. In another example, the software code may be expanded at a location by a generated code element. Such a code element is created herein by the machine learning model based on an interface test criterion. Before the generated code element can be integrated into the code, the code element must, for example, satisfy the interface test criterion. This ensures that the code element matches the code. Thus, in the method proposed here, a sufficiently large machine language understanding of the machine learning model is first used, but then it is ensured by automated testing that the generated code element fulfills the interface test criterion. The machine and hallucination-prone creativity of the machine learning model is used here, but is also channeled to the extent that only appropriate code elements for integration into the code are ultimately available for selection. As a result, the quality of the software code is ensured, i.e. the quality of the technical system, in particular the cyber-physical system, in particular at least one computing unit of the vehicle and/or the robot that is controlled, regulated and/or monitored by the software. At the same time, the work effort is significantly reduced. This allows reliable changes to the code to be made more often and more easily. This may improve the quality of the software.

The high degree of automation also enables the automated generation of a variety of code elements. In particular, thanks to automation, a code element can be generated as often as necessary until one of them satisfies the interface test criterion. Advantageously, variability (e.g., due to random selection) in the output of the machine learning model (which can be referred to in the technical jargon as temperature) is shown here. In other words, even in the case of repetitions based on identical input, the machine learning model may produce different outputs. Alternatively or additionally, the language specification can also be adapted to the code element to be created and/or the interface test criterion.

Advantageously, in the method proposed here, prompts can be extended to the machine learning model, in particular to a large language model (LLM), in order to satisfy properties, such as ranges of values, which must be met by the input values and output values of the code element to be generated. These properties may be obtained, for example, by calculating forward and backward of the already existing code by way of compositional verification with abstract interpretation. Alternatively or additionally, they may be from (manual) code annotations. In a second step, the code element generated by the machine learning model is automatically tested for adherence to these characteristics in a verification step.

This ensures that the code element generated by the machine learning model, i.e. the resulting code, fulfills guarantees regarding certain properties, e.g., compliance with certain ranges of values, formulated as pre- and post-conditions, as well as invariants. Conventionally, there are no guarantees for the generated code element, while the method proposed here ensures that the generated code element can at least safely handle all possible calls in the existing code and thereby only generates output values that fit for further use in the code.

The method is equally applicable for all common programming languages (abstract interpretation or other suitable formal methods for programming languages are also available) and—as previously—does not need to be expensively adapted or newly developed for a specific programming language.

Another advantage is that the resulting code elements and their test results can be used to train a domain-specific code element generator. For example, this may occur in the method according to the second general aspect (or one embodiment thereof). Thus, monitored fine tuning and/or unmonitored (reinforcement) learning may be performed based on the test results, thus improving the method according to the first general aspect (or one embodiment thereof). As a result, code elements may then be generated (in the future) that fit even better to a software code.

### BRIEF DESCRIPTION OF THE DRAWINGS

FIG. 1 schematically illustrates exemplary embodiments of a computer-implemented method for automated generation of a code element of a software code.

FIG. 2 schematically illustrates a computer-implemented method for further training of a machine learning model.

FIG. 3 illustrates an exemplary embodiment of the method for automated generation of a code element of a software code.

FIG. 4 illustrates an exemplary embodiment of the method for automated generation of a code element of a software code, wherein a gap in the code is to be closed or a previous code element in the code is to be replaced.

### DETAILED DESCRIPTION

The method 100 proposed in this disclosure is directed toward the automated generation of code elements of or for software.

The software may be configured to control, regulate and/or monitor a technical system, in particular a cyber-physical system, in particular at least one computing unit of a vehicle and/or a robot. In particular, the software may be embedded software that is designed to execute on an embedded (i.e., task-specific) system. Examples of using the software may include an engine and/or transmission controller, a brake controller, autonomous driving, machine perception for autonomous driving, a hybrid strategy, battery management, etc. Thanks to the test step 130, the method 100 can itself be used for safety-relevant software according to specified standards, e.g., ISO 26262 (functional safety).

For example, in method 100, prompts that are automatically passed to a machine learning model such as a Large Language Model (LLM) to generate one or more code elements, of a or for a code, can be expanded to include context (namely, at least by an interface test criterion). For example, the prompts may be expanded by additional context regarding the use of the code to be generated. Thus, the machine learning model has an opportunity to generate one or more code elements that satisfy this context. The one or more code elements generated by the machine learning model are automatically subjected to a verification as to whether they satisfy the context regarding their use. Method 100 may be performed in an electronic programming environment. Thus, the method may be engaged by a user interface.

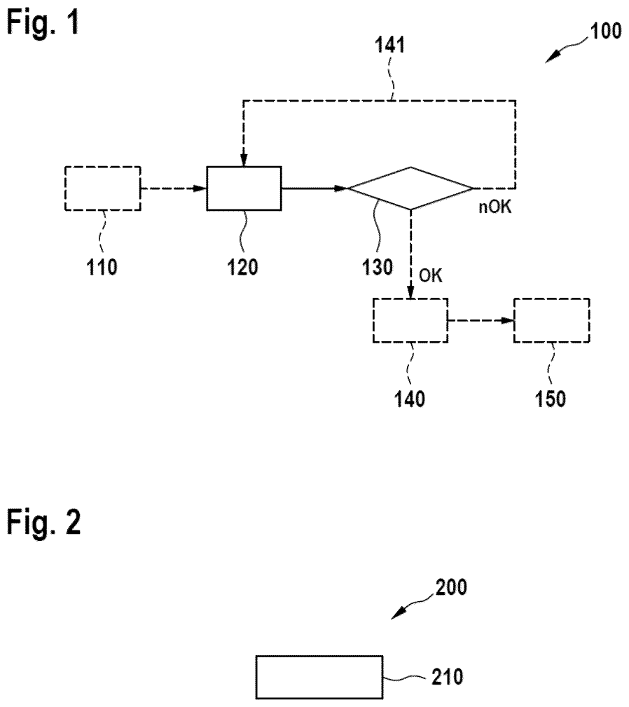

To this end, a computer-implemented method 100, such as schematically illustrated in FIG. 1, for the automated generation of a code element 50 of a software code 10 is first disclosed. The method 100 comprises generating 120, via (e.g., by) a machine learning model 40, the code element 50 based on a language specification 31 for the code element 50 to be created and an interface test criterion 32 to be satisfied by the code element 50 to be created.

The method 100 further comprises testing 130 whether the code element 50 satisfies the interface test criterion 32, wherein a test result is provided. Testing 130 may also be performed via (e.g., by) the machine learning model 40 or another machine learning model. Preferably, however, testing 130 does not occur via (and also does not by) the machine learning model 40, and does not occur via another machine learning model. For in this case, testing 130 is not subject to possible hallucinating by a machine learning model.

The software code 10 may be a source software code. The code may be written in one or more programming languages. For example, the code may be written in programming language C. Alternatively or additionally, the code may be written in the programming language Rust, for example. The machine learning model's sufficiently great language understanding eliminates the need to specify programming language(s). In other words, the method 100 may be applied to any code independent of the programming language or languages.

The code element may also be a code, hence a source software code or a part thereof. The code element may be part of a larger code. For example, the code element may comprise or be a function or procedure of the code.

The language, in particular natural language, specification 31 for the at least one code element 50 to be created can be a specification of the function or the procedure. For example, the language specification may include an input-output signature 12. An input-output signature 12 may be a specification of the input types and/or the output types. An exemplary input-output signature for a square root calculation function may be “double sqrt (double x)”.

The machine learning model 40 may include or be a Foundation Model. A Foundation Model can be a large machine learning model trained on a large amount of data on a large scale (often through self-monitored learning or semi-monitored learning) so that it can be adapted to a wide range of downstream tasks. In particular, the machine learning model may comprise or be a Large Language Model (LLM). A Large Language Model may be a language model that is distinguished by its size. In particular, the Large Language Model may be a chatbot and/or may have chatbot functionality. For example, Meta AI LLAMA can be used as the Large Language Model. Such a Large Language Model may be advantageous because it can be adapted, and in particular, its weights and/or distortions can be adapted, for example, by using the method 200. Alternatively or additionally, for example, Google Gemini may be used. Alternatively or additionally, OpenAI ChatGPT (e.g., in the version dated May 24, 2023) can be used as the Large Language Model, for example. Alternatively or additionally, Hugging Face Bloom can be used as the Large Language Model, for example. Alternatively or additionally, the machine learning model may comprise or be a Foundation Model (also: a multi-domain model). Here, for example, OpenAI GPT-4 (e.g., in the version dated Mar. 14, 2023) can be used.

Interface test criterion 32 may include a pre-condition 33 to an input of the function. The input here may comprise one or more input variables. Pre-condition 33 may comprise one or more sub-conditions for the one or more input variables. For example, the interface test criterion does not require a post-condition 34 if the code element does not have any output variables. Alternatively or additionally, interface test criterion 32 may comprise a post-condition 34 to an output of the function. The output here may comprise one or more output variables. Post-condition 34 may comprise one or more sub-conditions for the one or more output variables. For example, the interface test criterion does not require a pre-condition 33 if the code element does not have any input variables, e.g., because it is to be upstream of the existing code.

In particular, interface test criterion 32 may include both a pre-condition 33 to an input of the function and a post-condition 34 to an output of the function. For example, the interface test criterion requires both a pre-condition and a post-condition when, as exemplified in FIG. 4, the code element is to fill a gap in a chain of calculations of the code or replace a chain link.

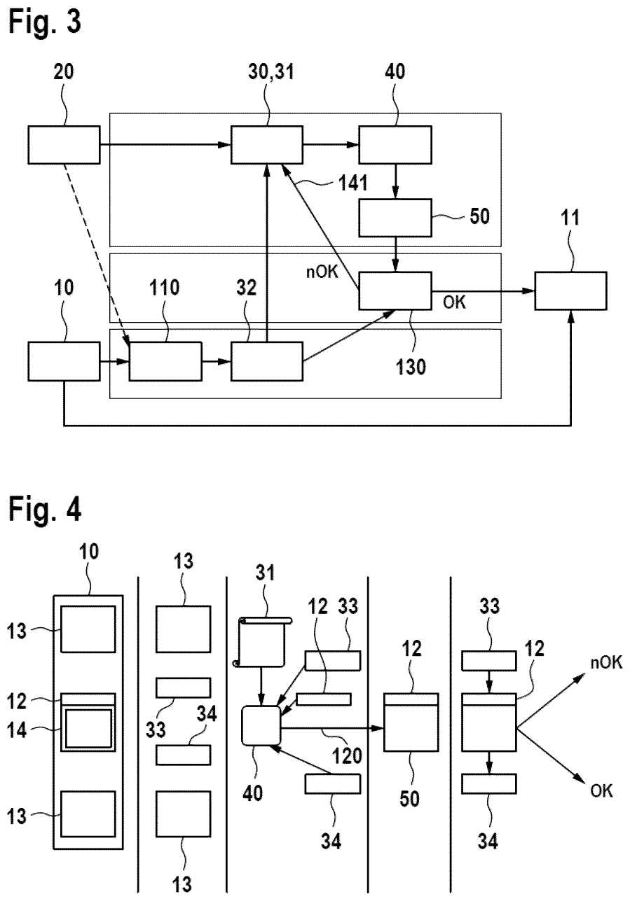

A prompt 30 to machine learning model 40 may include language specification 31 as exemplarily illustrated in FIG. 3. Alternatively or additionally, the prompt may comprise interface test criterion 32. In particular, the prompt may comprise both the language specification and the interface test criterion. On the other hand, the language specification 31 and the interface test criterion 32 may also be provided as input values to the machine learning model outside of a prompt 30. The prompt may be a natural language text.

Satisfaction of interface test criterion 32 may require satisfaction of pre-condition 33 and/or post-condition 34. In particular, the interface test criterion may be satisfied by a code element precisely when the pre-condition and/or post-condition are satisfied by the code element. For example, testing 130 whether the code element satisfies the interface test criterion may include static analysis. For example, static analysis may be based on abstract interpretation. Here, the code element is not executed. Alternatively or additionally, testing 130 whether the code element satisfies the interface test criterion may include dynamic analysis. For example, dynamic analysis may include fuzzing. Here, the code element is executed on a plurality of inputs, wherein a plurality of outputs are generated. In particular, testing 130 whether the code element satisfies the interface test criterion may include static analysis and dynamic analysis.

Both static and dynamic analysis may be automated. Their results, especially if they are not sufficiently positive (“nOK”, short for not OK), can be used as needed in a further language specification for a further code element to be created in a re-execution of the method 100.

The test result may comprise a natural language text or may be such a natural language text. Alternatively or additionally, the test result may comprise a data structure written in a predetermined syntax (e.g., in a programming language) or may be such a data structure. For example, the data structure may comprise the natural language text. The test result may comprise one or more numerical values, in particular one or more confidence values. As a result, a quality of the at least one code element 50 may be encoded, which may be considered when asking whether the code element is incorporated into the code 140.

If generation of a code element is not successful, the test result may comprise information that the generation of the at least one code element failed. This may happen, for example, if the language specification 31 (and/or the prompt 30) and/or the interface test criterion, sometimes derived from erroneous code, are already contradictory. This information is also valuable for the development of the technical system. In this case, the language specification and/or the interface test criterion, optionally also the code from which they were derived, can and must then be adapted and in particular improved.

The method 100 may further be directed toward integrating a generated code element 50 into the code 10. The method 100 may include, as illustrated as an option in FIG. 1, integrating 140 the code element into the code 10, at least when the test result is sufficiently positive (“OK”), wherein a revised code 11 results. For example, code 10 may be expanded by the generated 120 code element 50 or a previous code element in the code may be replaced with the generated 120 code element 50.

The method 100 may further include compiling the revised code 11. The method 100 may further comprise, such as illustrated as an option in FIG. 1, executing 150 the revised code (e.g., in compiled form) in a technical system, in particular a cyber-physical system, in particular in a computational unit of a vehicle and/or a robot. In this respect, the method 100 may also be a method of producing a software code of a technical system.

The method 100, such as illustrated as an option in FIG. 1, may further comprise repeating 141 of the method 100 if the test result is not sufficiently positive (“nOK”). A multitude of repetitions is possible. However, the language specification 31 for the at least one code element 50 to be created does not have to be changed, because the machine learning model 40 can generate different outputs, even if the input is identical. In other words, the machine learning model may have a temperature. On the other hand, the machine learning model may also be changed (e.g., by method 200 for further training of the machine learning model).

The method 100 may include deriving 110 the interface test criterion 32 based on the code, particularly via abstract interpretation. Alternatively or additionally, the method 100 may include deriving 110 the interface test criterion based on at least one manual annotation in the code. In particular, the method 100 may include deriving 110 the interface test criterion based on the code, particularly via abstract interpretation and on at least one manual annotation in the code. The automatic derivation 110 of the interface test criterion also allows, in particular, the automatic derivation of a plurality of interface test criteria at different locations in the code. Thus, the code may be automatically revised at a plurality of locations by the method 100 (e.g., based on a decomposition of the code into functions and/or procedures). Such a procedure may be appropriate, for example, if a code is to be translated from one programming language (e.g., C) to another programming language (e.g., Rust). Due to the decomposition of the code, individual functions and/or procedures can be translated separately. This allows the base structure of the code to be maintained even after the translation. In addition, the decomposition of the code may, for example, depict responsibilities of various programmers.

The method 100 may include receiving the code 10. Alternatively or additionally, the method 100 may include receiving the language specification 31 and/or the prompt 30, wherein the order of such steps may be irrelevant. Alternatively or additionally, the method 100 may include receiving the machine learning model 40. The method 100 may include receiving a change request 20 for the code 10. The prompt and/or the language specification can be based on the change request 20.

The method 100 may comprise outputting the code element 50 and/or the test result. This may be done, for example, via the electronic programming environment.

The method 100 may be based on at least one input of a user of an interface of the electronic programming environment. For example, the method 100 and/or its multiple executions may be (interactively) controlled via the electronic programming environment. This may be helpful, for example, if a test result for a generated code element is not yet sufficiently positive. Alternatively or additionally, the interactive control may be helpful in debugging the automated run of method 100. Alternatively or additionally, for example, via an input after test case generation, an interactive selection of the desired code element may be made prior to proceeding to integrating 140 the code element into the code.

The method 100 may also generate, via the machine learning model 40, a plurality of code elements 50 based on one or more language specifications 31 of the code elements to be created and an interface test criterion 32 to be satisfied by the code elements to be created.

The method 100 may also test whether any of the generated code elements 50 satisfies the interface test criterion 32.

For example, one or more code elements of the plurality of code elements may be generated based at least on the language specification, i.e., in an (only) execution of method 100. Alternatively or additionally, one or more code elements of the plurality of code elements may be generated by multiple executions of method 100. Advantageously, in multiple embodiments of method 100, the language specification and/or the prompt may be varied. On the other hand, the language specification and/or prompt need not be varied in multiple embodiments of method 100. Alternatively or additionally, in multiple embodiments of method 100, the machine learning model may be varied.

Natural language text in method 100 may be in English. This may be advantageous because most machine learning models have currently not been trained solely but predominantly in English.

It further discloses a computer-implemented method 200 for further training of a machine learning model, wherein the machine learning model is configured to generate a code element of a software code based on a language specification for the code element to be created and an interface test criterion to be satisfied by the code element to be created. For example, as shown schematically in FIG. 2, the method 200 may include adapting 210 the machine learning model based on a code element and a test result (as well as language instruction to the machine learning model, if any), wherein the test result is provided by testing 130 whether the code element satisfies the interface test criterion.

Testing 130 may be, but need not be, part of the method 200. The code element may have been generated 120 and tested 130 according to method 100 for the automated generation of a code element of a software code, wherein the test result was provided. The method 200 may, but need not be, a continuation of the method 100.

Alternatively or additionally, the method 100 may be re-executed via an adapted machine learning model. In particular, the machine learning model may be adapted between multiple executions of the method 100 according to the method 200.

The machine learning model may be adapted by way of supervised learning. Such adaptation to the machine learning model can be seen as supervised fine tuning. Due to the fine tuning, a generic machine learning model, which has been trained on, for example, a general machine language understanding, can be customized, i.e., here with respect to generating code elements for a code. The fine tuning of the machine learning model may, but need not, be preceded by a further adaptation of the machine learning model by unsupervised (reinforcement).

Alternatively or additionally, adapting the machine learning model based on at least one code element and at least one test result may comprise calculating at least one reward at least based on the at least one test result and adapting the machine learning model based on at least one code element as well as the at least one reward. Such adaptation of the machine learning model can be seen as unsupervised (reinforcement) learning. As a result, a generic machine learning model that has been trained on, for example, a general machine language understanding, and/or such a model after fine-tuning, may be (further) adapted in an application-specific manner, i.e., herein with respect to generating code elements for a code. As such, the machine learning model may be even better adapted to the generation of code elements for a code.

A reward may be a parameter, in particular a numerical parameter, comparable to other parameters that are also rewards. For example, a reward may be greater than, the same as, or less than another reward.

The at least one reward may be greater if the at least one test result is better, and the at least one reward may be less if the at least one test result is worse.

A test result may be worse, in particular bad, if a test (e.g. with regard to a plurality of generated code elements) on which the test result is based is negative, i.e., has not been passed. Alternatively or additionally, a test result may be better, in particular good, if all tests were positive, i.e., passed, for example.

The machine learning model may be adapted based at least on a plurality of code elements (as well as any associated language instructions to the machine learning model) and a plurality of associated rewards. The method may include calculating the rewards based at least on a plurality of test results per code element of the plurality of code elements. In other words, the reward for a code element does not only need to depend on its test result, but can also be based on one or more test results for other code elements. For example, one or more rewards (i.e., the amount thereof) may depend on a number of test results. Alternatively or in addition, one or more rewards may depend on a number of better test results and a number of worse test results, particularly on an imbalance between better and worse test results. Alternatively or additionally, first rewards may be calculated per test result and then adjusted and/or offset based on other test results.

The adaptation of the machine learning model can be based on a reinforcement learning algorithm such as, for example, Proximal Policy Optimization (PPO).

A portion of the machine learning model cannot be adapted (deliberately), i.e. fixed. Here, only another part of the machine learning model is adapted.

For example, certain parameters such as weights and/or distortions, in particular weights and/or distortions on previous layers of the machine learning model, may not be adapted, i.e. be fixed. For example, the adaptations may be limited to rear layers of the machine learning model. This may ensure that the machine learning model does not excessively deteriorate with respect to machine language understanding. On the other hand, a deterioration of the machine language understanding can be targeted by the adaptation to the extent that it does not play a role in generating code elements for a code. For example, (usually) machine language understanding of Shakespeare English is not necessary for generating code elements.

The method 200 may be controlled via the electronic programming environment. In particular, the machine learning model may be further adapted via the electronic programming environment.

In the exemplary embodiments of the method 100 illustrated in FIG. 3, a change request 20 may first be received in natural language for a given code, for example, such as implementing or revising (refactoring) a certain function or procedure, wherein such function or procedure may also be a gap or a previous code element as in the exemplary embodiments of the method 100 shown in FIG. 4. Revising may also include the case of a translation from one programming language to another, e.g., from C to Rust. Based on the code 10, first a compositional verification can be applied by way of abstract interpretation in order to obtain one or more pre-conditions 33 and/or one or more post-conditions 34 and, optionally, one or more invariants for the stated change request 20. This step may implement the derivation 110 of interface test criterion 32 based on the code 10. If new code (i.e. a new code element 50) is to be created for an existing code 10, there is already a place in the code 10, where the new code (i.e. the generated code element 50) is to be inserted, e.g. in FIG. 4. If code is to be revised, a previous code element is replaced by the newly generated code element 50.

A prompt 30 to the machine learning model 40 (in particular to the LLM) may further be created, wherein the prompt 30 may comprise the language instruction 31. For this purpose, the change request 20 can be encoded with the functional properties to be achieved, any necessary context with regard to the code, as well as the pre-conditions 33 and/or post-conditions 34, as well as optionally the invariants. In the case of refactoring, at least one previous code element may additionally be contained in the prompt. It is also conceivable that further data about the code 10, such as coding guidelines, documentation, etc. may be included at least in parts in the prompt 30. The machine learning model 40 may process the prompt 30 and/or other input values (for the language instruction, the interface criterion, the input-output signature 12, etc.) and at least one new code element 50 is output or extracted from the machine learning model response. This new code (i.e., the at least one new code element 50) is checked for compliance with the one or more pre-condition 33 and/or the one or more post-condition, as well as optionally the one or more invariants, when used by the code. This may be done by one or more formal methods, such as abstract interpretation, fuzzing, and/or testing, wherein different levels of guarantees are given. If testing 130 is successful (“OK” in FIGS. 3-4), the revised code 11 may be issued with corresponding guarantees. If, on the other hand, testing 130 fails (“nOK” in FIGS. 3-4), the prompt 30 can be revised to improve the error in a repeat of the method 100. In theory, failures can occur infinitely. However, in practice, this is extremely unlikely (as long as one is asked to do a viable task), since a machine learning model can eventually be brought to appropriate outputs through its internal parameters and appropriate prompts. However, one can also install a counter for safety here and return the best suggestion after a predetermined number of steps, e.g. 10 steps, with corresponding information regarding any deficiencies. In fact, if the machine learning model does not find a sufficiently positive solution, the problem with the information collected may also be returned to the user of the electronic programming environment so that the user can formulate a new, refined prompt based on it. Optionally, in this case, the user may also be replaced by another machine learning model.

An exemplary flow of the method 100 can be seen in FIG. 4. An example of a code 10 consisting of two functions 13 and a location 14 in which new code is to be inserted first (first column in FIG. 4) is shown here. In an analysis step (second column in FIG. 4), e.g., by way of compositional verification with abstract interpretation, based on the existing functions 13, pre-conditions 33 and post-conditions 34 (generally: the interface criterion 32) may be calculated for the location to be processed (“gap”). These may be utilized in the next step (third column in FIG. 4), e.g., to generate the prompt 30 for the machine learning model 40 (e.g., for the LLM). In addition, the language specification for the code elements to be created, i.e., a (functional) specification for the location to be processed, can be used, as can the input-output signature of the function to be generated. The prompt may also include an instruction as to whether to generate new code. In the next step (fourth column in FIG. 4), the machine learning model 40 generates 120 a code element 50 based on the generated prompt 30. This code element 50 may then be tested 130 for compliance with pre-conditions 33 and post-conditions 34 (generally of interface criterion 32) in the final step (fifth column in FIG. 4) using existing formal methods. If the test result is sufficiently positive, the gap 12 may be closed by the generated 120 code element 50.

An example is provided below. As most current machine learning models handle English better than German, the example is in English (and in C).

First example prompt:
“Generate a square root function with the following signature: double sqrt (double x).

It should realize the square root functionality: In mathematical terms, if you have a number x, its square root is another number y, which when squared (meaning y*y) equals x. To illustrate, both 4 and −4 are square roots of 16, as squaring them (4*4 or −4*−4) gives us 16.

Each non-negative real number x has a singular non-negative square root, often termed the principal square root or just the square root. This is represented as \sqrt{x}, with the symbol \sqrt{ } known as the radical sign or radix. For instance, the principal square root of 9 is 3, denoted as \sqrt{9}=3. The number or expression that we're finding the square root of is called the radicand, which in this example is 9. For any non-negative x, the principal square root can also be expressed in exponent notation as x\hat{ }(½).

The generated square root function only needs to handle non-negative input values and should only produce non-negative output values.”

This prompt, therefore, contains an interface criterion comprising the precondition

“/// [[ requires : x >= 0.0 ]]”
as well as the post-condition
“/// [[ ensures : return >= 0.0 ]]”

First code element generated by the machine learning model based on the first example prompt:

″#include <math.h>
#include <stdio.h>
double sqrt(double x) {
if (x < 0) {
printf(″Negative input to the sqrt function is not allowed.\n″);
return −1;
}
double guess = x / 2.0;
while (1) {
double better_guess = 0.5 * (guess + x / guess);
if (fabs(guess − better_guess) < 0.000001) {
return better_guess;
}
guess = better_guess;
}
}
int main( ) {
printf(″%f\n″, sqrt(9)); // outputs: 3.000000
return 0;
}“

Example of verification output when testing whether the generated code element satisfies the interface criterion. Here, Astrée was used as a tool for abstract interpretation.

| ″[ | call#main at sqrt.c:374.4-8 |
|---|---|
| call#sqrt at sqrt.c:375.19-26 | |
| loop>=2 at sqrt.c:365.4-371.5 | |
| ALARM (A) float_division_by_zero: divisor in | |
| [−8.988465674311579e+307, | |
| 8.988465674311579e+307] at sqrt.c:366.45-54 ] | |
| > | double better_guess = 0.5 * (guess + x / guess); |

>“

Thus, the error was found here that a division by zero can occur in the generated code element, since x=0 is permitted according to the pre-condition.

Example of a further prompt directed to correct the still erroneous code element: “In your previous attempt you produced code that could lead to a float division by zero in the following line: double better_guess=0.5*(guess+x/guess).”

Second code element generated by the machine learning model based on the further prompt (change to the first example output highlighted in bold):

″#include <math.h>
#include <stdio.h>
double sqrt(double x) {
if (x < 0) {
printf(″Negative input to the sqrt function is not allowed.\n″);
return −1;
}
double guess = x / 2.0;
if (guess == 0) {
return 0;
}
while (1) {
double better_guess = 0.5 * (guess + x / guess);
if (fabs(guess − better_guess) < 0.000001) {
return better_guess;
}
guess = better_guess;
}
}
int main( ) {
printf(″%f\n″, sqrt(9)); // outputs: 3.000000
return 0;
}“

The error in the generated code element was indeed corrected correctly. This example also shows that generating 130 the code element may be based on a previously generated code element and/or a previously used prompt.

A computer system designed to perform the computer-implemented method 100 for automated generation of a code element of a software code is further disclosed. Alternatively or additionally, the computer system may be designed to perform the computer-implemented method 200 for further training of a machine learning model. In particular, the computer system may be designed to perform the computer-implemented method 100 for automated generation of a code element of a software code and (e.g., subsequently) the computer-implemented method 200 for further training of a machine learning model. The computer system can comprise a processor and/or a working memory.

A computer program adapted to perform the computer-implemented method 100 for automated generation of a code element of a software code is further disclosed. Alternatively or additionally, the computer program may be designed to perform the computer-implemented method 200 for further training of a machine learning model. In particular, the computer program may be designed to perform the computer-implemented method 100 for automated generation of a code element of a software code and (e.g., subsequently) the computer-implemented method 200 for further training of a machine learning model. The computer program may, for example, be present in interpretable or compiled form. For execution, it may be loaded (also in portions) into the RAM of a computer, for example, as a bit or byte sequence.

Furthermore disclosed is a computer-readable medium or signal, which stores and/or contains the computer program. The medium may, for example, comprise one of RAM, ROM, EPROM, HDD, SDD, . . . on/in which the signal is stored.

What is claimed is:

1. A computer-implemented method for automated generation of a code element of a software code, comprising:
generating, via a machine learning model, the code element based on a language specification for the code element to be created and an interface test criterion to be satisfied by the code element to be created; and
testing whether the code element satisfies the interface test criterion, wherein a test result is provided.

2. The method according to claim 1, wherein the software is configured to control, regulate, and/or monitor a technical system.

3. The method according to claim 1, wherein the method is performed in an electronic programming environment.

4. The method according to claim 1, further comprising:
integrating the code element into the code, at least when the test result is sufficiently positive, wherein a revised code results; and
wherein the code is expanded by the code element or a previous code element in the code is replaced by the code element.

5. The method according to claim 4, further comprising:
executing the revised code in a technical system.

6. The method according to claim 1, further comprising:
deriving the interface test criterion based on the code via abstract interpretation, and/or on at least one manual annotation in the code.

7. The method according to claim 1, wherein the code element comprises a function or procedure of the code, and wherein the language specification for the code element to be created comprises a specification of the function or procedure.

8. The method according to claim 7, wherein the interface test criterion comprises a pre-condition for an input of the function and/or a post-condition for an output of the function, and wherein satisfying the interface test criterion requires satisfying the pre-condition and/or the post-condition.

9. The method according to claim 1, wherein testing whether the code element satisfies the interface test criterion comprises static analysis and/or dynamic analysis.

10. The method according to claim 1, further comprising:
repeating the method if the test result is not sufficiently positive.

11. A computer-implemented method for further training of a machine learning model, wherein the machine learning model is designed to generate a code element of a software code based on a language specification for the code element to be created and an interface test criterion to be satisfied by the code element to be created, the method comprising:
adjusting the machine learning model based on a code element and on a test result, wherein the test result is the result of testing whether the code element satisfies the interface test criterion.

12. The method according to claim 11, wherein the code element was generated and tested.

13. A computer system designed to carry out the computer-implemented method according to claim 1.

14. The computer program designed to carry out the computer-implemented method according to claim 1.

15. A computer-readable medium or signal that stores and/or contains the computer program of claim 14.

16. The method according to claim 1, wherein a prompt to the machine learning model comprises the language specification and the interface test criterion.

17. The method according to claim 2, wherein the technical system is a cyber-physical system.

18. The method according to claim 17, wherein the cyber-physical system is a computing unit of a vehicle and/or a robot.

19. The method according to claim 1, wherein the code element comprises a function or procedure of the code, and wherein the language specification for the code element to be created comprises a specification of the function or procedure, and an input-output signature.

20. The method according to claim 1, further comprising:
repeating the method if the test result is not sufficiently positive, wherein the language specification for the code element and/or the machine learning model is changed.
